(19) United States
(12) Patent Application Publication
(10) Pub. No.: US 2026/0097856 A1
(43) Pub. Date: Apr. 9, 2026

(54) Mount with Plastically Straining Load Absorption Device

(71) Applicant: The Boeing Company, Arlington, VA (US)

(72) Inventors: Reed Daniel Wilson, Kirkland, WA (US); Kyle David Stevens, Mill Creek, WA (US); Ryan James Clabots, Mukilteo, WA (US); Donald Thomas Powell, Everett, WA (US); Adrian Stanescu, Maple Valley, WA (US)

(21) Appl. No.: 19/324,625

(22) Filed: Sep. 10, 2025

Related U.S. Application Data
(60) Provisional application No. 63/704,188, filed on Oct. 7, 2024.

(51) Int. Cl. B64D 29/06

(52) U.S. Cl. CPC B64D 29/06

(57) ABSTRACT

A mount to connect a fan cowl support beam to a fan case. The mount comprises a connector with spacers. The spacers have slots that are positioned between a first end and a second end. The spacers are configured to buckle upon application of a force from the fan case that is above a predetermined amount to absorb a portion of the force.

### RELATED APPLICATIONS

This application claims the benefit of U.S. Provisional Application No. 63/704,188, filed on Oct. 7, 2024, which is hereby incorporated by reference in its entirety.

### TECHNOLOGICAL FIELD

The present disclosure relates generally to the field of mounts for connecting first and second members and, more specifically, to mounts that include a spacer.

### BACKGROUND

A jet engine of an aircraft includes a nacelle that extends around the exterior of the engine. The nacelle forms an aerodynamic housing for the engine. The nacelle is often divided into multiple sections. Examples of sections include one or more cowls such as an inlet cowl, fan cowl, and a thrust reverser cowl. The nacelle includes an aerodynamic shape due to its exposed position on the exterior of the aircraft, such as on the wing of the aircraft. The nacelle is also shaped to be aerodynamically efficient.

The nacelle is designed to withstand a fan blade off (FBO) event that involves a fan of the engine. During an FBO event, a blade of the fan breaks off or is otherwise released from the fan. The high rotational speed of the fan causes the released blade to be propelled radially outward away from the engine and into contact with the engine fan case. The released blade imparts a large amount of energy to the engine fan case which is turn is transferred to other parts of the aircraft, such as the fan cowl support beam, fan cowl, and other nacelle components.

Mounts connect a fan cowl support beam to the fan case. The mounts are designed to withstand an FBO event and maintain its connection to the fan case. To account for an FBO event, existing solutions include increasing the size and strength of the mounts to handle the increased loads. However, this is an issue for this type of situation where the loading is based on a forced deflection. Making the mounts larger and stronger results in a stiffer design which tends to cause the mounts to pick up additional load. Further, the larger designs are not efficient as they add weight to the aircraft. Thus, a mount design is needed that maintains the connection between the fan cowl support beam and the fan case during an FBO event without greatly decreasing the aircraft efficiency.

### SUMMARY

One example is directed to a mount to connect a fan cowl support beam to a fan case. The mount comprises a fitting with a first end configured to connect to the fan case and a second end. A plurality of fasteners that connect the second end of the fitting to the fan cowl support beam. The plurality of fasteners comprises an elongated body and a spacer that extends around the body. The spacers are configured to buckle upon application of a force from the fan case that is above a predetermined amount to absorb a portion of the force. The elongated bodies are configured to withstand the force and maintain the connection between the fitting and the fan cowl support beam.

In another example, the fasteners comprise the spacers having a cylindrical shape with a hollow interior and with one of the elongated bodies extending through the hollow interior.

In another example, one or more of the spacers comprises one or more slots that extend along the length.

In another example, one or more of the elongated bodies comprises a threaded bolt.

In another example, the fitting comprises a flange at the second end with the plurality of fasteners extending through the flange to connect the fitting to the fan cowl support beam.

In another example, two or more of the fasteners extend through each of a first side and a second side of the fitting.

In another example, the second end of the fitting has a flat face that contacts against a corresponding face on the fan cowl support beam.

In another example, the spacer is configured to buckle upon the application of the force away from the fan cowl support beam.

One example is directed to a mount to connect a fan cowl support beam to a fan case. The mount comprises: a first member with an outer end configured to be connected to the fan cowl support beam; a second member with an outer end configured to be connected to the fan case, with the first member and the second member being colinearly aligned; and a spacer that extends around inner ends of the first member and the second member. The spacer is configured to buckle upon application of a force from the fan case that is above a predetermined amount. The mount is configured to maintain the connection between the fitting and the fan cowl support beam upon application of the force above the predetermined amount.

In another example, the first member is a single rod.

In another example, the first member, the second member, and the spacer are a single piece.

In another example, the spacer comprises a cylindrical shape with a hollow interior that receives the inner ends of the first member and the second member.

In another example, the first member and the second member are separate members connected together by the spacer.

In another example, the slots are spaced apart around a periphery of the spacer.

In another example, the spacer comprises a plurality of slots that extend along the length and around a periphery of the spacer.

In another example, the spacer is hollow.

In another example, the spacer is solid.

One example is directed to a mount to connect a fan case to a fan cowl support beam. The mount comprises an elongated body and a spacer that extends around the elongated body with the spacer comprising a plurality of slots. The spacer is configured to buckle upon application of a force from the fan case that is above a predetermined amount to absorb a portion of the force. The elongated body is configured to withstand the force and maintain the connection between the fitting and the fan cowl support beam.

In another example, the elongated body is a bolt.

In another example, the elongated body comprises a first rod and a second rod.

In another example, the spacer comprises a cylindrical shape with a hollow interior space that receives the elongated body.

In another example, the slots are spaced apart around the periphery of the spacer.

One aspect is directed to a method of connecting a fan cowl support beam to a fan case. The method comprises: supporting the fan cowl support beam with a mount; receiving a force below a predetermined amount and supporting the fan cowl support beam with the mount in an unbuckled state; receiving a force above the predetermined amount and buckling the mount; and supporting the fan cowl support beam with the mount after buckling the spacer.

In another example, the mount comprises an elongated body with a spacer and receiving the force above the predetermined amount and buckling the spacer and absorbing a portion of the force that is passed from the fan case to the fan cowl support beam.

In another example, the method further comprises twisting the spacer when receiving the force that is above the predetermined amount.

In another example, the elongated body comprises a first section that is connected to the fan cowl support beam and a second section that is connected to the fan case end and spacing apart the first section and the second section with the spacer.

In another example, the method further comprises buckling the spacer along slots that extend within the spacer.

In another example, the method further comprises maintaining a shape of the spacer when the force is below the predetermined amount.

One aspect is directed to a method of connecting a fan cowl support beam to a fan case. The method comprises: supporting the fan case with a plurality of fasteners; receiving a force below a predetermined amount and supporting the fan case with the plurality of fasteners; receiving a force above the predetermined amount and buckling spacers on the fasteners; and supporting the fan case with elongated members that extend through the spacers after buckling the spacer.

One aspect is directed to a mount to connect a first member to a second member. The mount comprises a fitting with a first end configured to connect to the first member and a second end. A plurality of fasteners connect the second end of the fitting to the second member. The plurality of fasteners comprise an elongated body, and a spacer that extends around the body. The spacers are configured to buckle upon application of a force from the first member that is above a predetermined amount to absorb a portion of the force. The elongated bodies are configured to withstand the force and maintain the connection between the fitting and the second member.

One aspect is directed to a mount to connect a first member to a second member. The mount comprises a first member with an outer end configured to be connected to the second member. A second member with an outer end is configured to be connected to the first member with the first member and the second member being colinearly aligned. A spacer extends around inner ends of the first member and the second member with the spacer comprising a plurality of slots that extend along the length. The spacer is configured to buckle upon application of a force from the first member that is above a predetermined amount. The mount is configured to maintain the connection between the fitting and the second member upon application of the force above the predetermined amount.

One aspect is directed to a mount to connect a first member to a second member. The mount comprises an elongated body, and a spacer that extends around the elongated body with the spacer comprising a plurality of slots. The spacer is configured to buckle upon application of a force from the first member that is above a predetermined amount to absorb a portion of the force. The elongated body is configured to withstand the force and maintain the connection between the fitting and the second member.

The features, functions and advantages that have been discussed in these examples can be achieved independently in various aspects or may be combined in yet other aspects, further details of which can be seen with reference to the following description and the drawings.

### BRIEF DESCRIPTION OF THE DRAWINGS

FIG. 1 is an isometric view of an aircraft that includes engines connected to the wings.

FIG. 2 is a schematic section view of an engine with a fan cowl support beam attached to a fan case.

FIG. 3 is an isometric view of a mount that connects a fan cowl support beam to a fan case.

FIG. 4 is an isometric view of a mount that connects a fan cowl support beam to a fan case.

FIG. 5 is an isometric view of the opposing side of the mount of FIG. 4.

FIG. 6 is a schematic sectional view of a fastener that includes a central bolt and a surrounding spacer.

FIG. 7 is an isometric view of a mount that connects a fan cowl support beam to a fan case.

FIG. 8 is a schematic diagram of mounts that connect together a first member and a second member.

FIG. 9 is a flowchart diagram of a method of connecting a fan cowl support beam to a fan case.

FIG. 10 is a flowchart diagram of a method of connecting a fan cowl support beam to a fan case.

### DETAILED DESCRIPTION

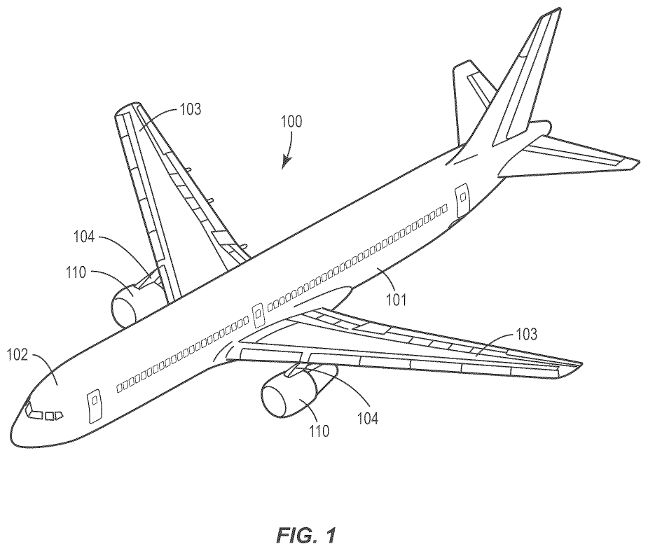

FIG. 1 illustrates an aircraft 100 configured to transport passengers and/or cargo. The aircraft 100 generally includes a fuselage 101 with an interior space configured to accommodate the passengers and/or cargo. The interior space of the fuselage 101 also includes a flight deck 102 with various controls to enable flight personnel to control the aircraft 100. Engines 110 are mounted on the wings 103 on opposing sides of the fuselage 101. The engines 110 are mounted under the wings 103 to strut boxes 104.

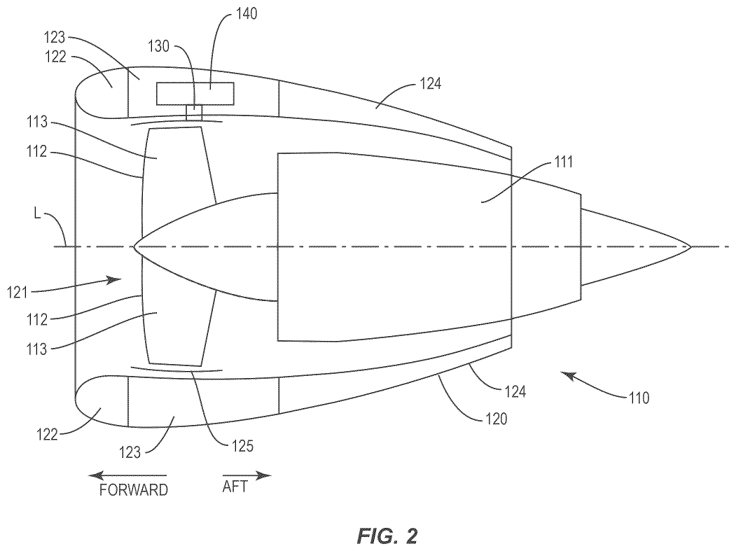

FIG. 2 schematically illustrates a sectional view of the engine 110. The engine 110 includes an engine core 111 and a nacelle 120. The engine core 111 can include a variety of different configurations, including but not limited to a gas turbine engine. The engine 110 includes a fan 112 with blades 113 to draw air into the engine core 111. A fan case 125 is positioned radially outward from the fan 112. The nacelle 120 extends around and protects the engine core 111 and fan 112. The nacelle 120 includes a generally cylindrical shape with an inlet 121 through which air is drawn into the fan 112 and engine core 111. The nacelle 120 is divided into multiple different sections along its length. An inlet cowl 122 is positioned at a forward end of the nacelle 120. A fan cowl 123 is positioned aft of the inlet cowl 122 and is aligned to extend around the fan 112. The nacelle 120 also includes a thrust reverse cowl 124 aft of the fan cowl 123. The thrust reverser cowl 124 is configured to translate along a longitudinal axis L relative to the engine core 111. One or more mounts 130 connect the fan cowl support beam 140 to the fan case 125.

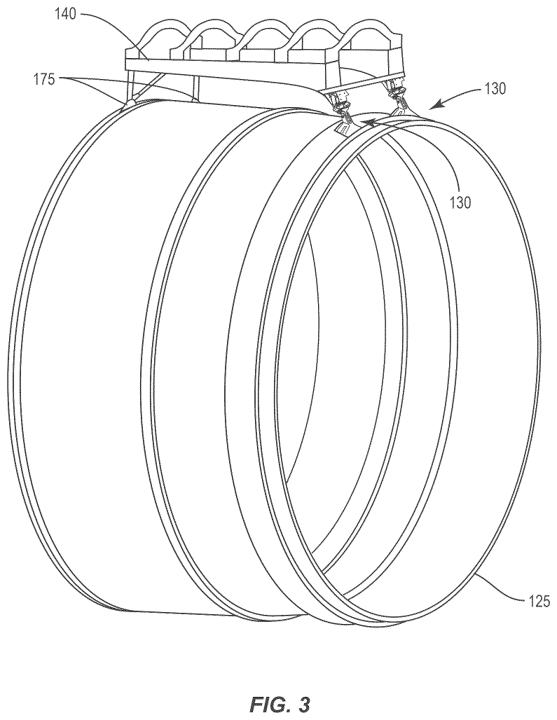

FIG. 3 illustrates the fan cowl support beam 140 connected to the fan case 125. One or more mounts 130 connect the fan cowl support beam 140 to the fan case 125. In some examples, one or more additional mounts 175, such as forward mounts, further connect the fan cowl support beam 140 to the fan case 125.

During normal operations such as during normal flight conditions, the fan case 125 applies loads to the fan cowl support beam 140. These loads are below a predetermined threshold and the mounts 130 are configured to accommodate the loads and maintain the connection. During an FBO event, one or more of the blades 113 break off from the fan 112. This can include an entire blade 113 or a section of the blade. A large initial force is exerted on the fan case 125 due to this contact with the fan blade 113. Further, a large force/deflection wave is generated that travels around the fan case 125 as the now unbalanced fan 112 continues to spin during engine rundown. After run down, the engine 110 will continue to windmill for the remainder of the flight in which the FBO event occurred. This will produce a high number of low load cycles due to the imbalanced load.

The loads that are applied during the FBO exceed the predetermined threshold of the typical flight loads. The mounts 130 are designed to withstand these loads and maintain the fan cowl support beam 140 connected to the fan case 125. The mounts 130 are further configured to enable movement between the fan case 125 and the fan cowl support beam 140 upon application of the FBO load above the predetermined threshold. The mounts 130 are configured to buckle which absorbs energy and helps to protect the fan cowl support beam 140. The mounts 130 are further configured to maintain the connection between the fan cowl support beam 140 and fan case 125 after the buckling.

The mounts 130 are designed to buckle when a force is applied that is above the predetermined threshold. In some examples, the predetermined threshold is slightly higher than the loads that are expected to be experienced during normal flight operations. The force amounts are based on one or more of historical data taken from other aircraft and calculated forces based on the construction of the engine 110 and the operational settings of the engine 110.

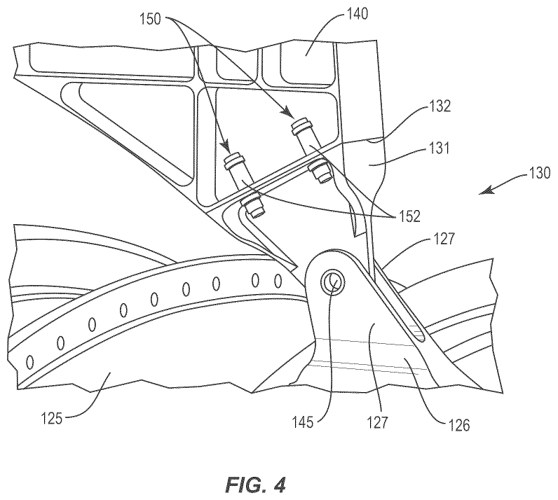

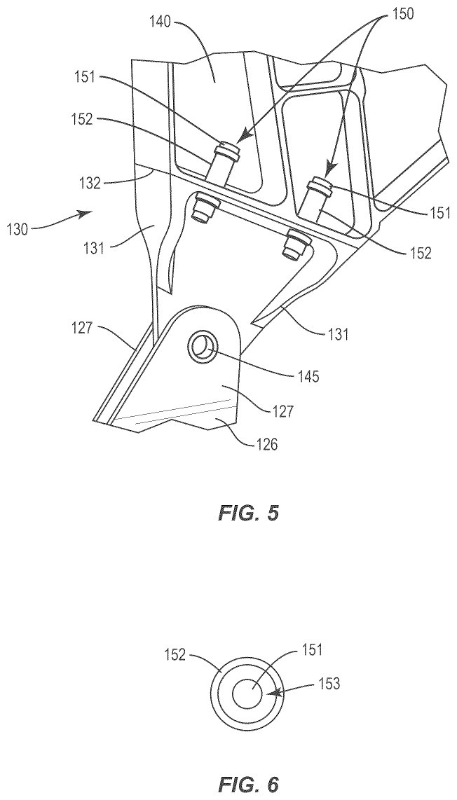

FIGS. 4 and 5 illustrate a mount 130 that connects the fan cowl support beam 140 to the fan case 125. The number and positioning of mounts 130 to make the connection can vary. A lug fitting 131 is positioned between clevis arms 127 of a fan case fitting 126 on the fan case 125. A connector 145 such as a bolt extends through openings in the lug fitting 131 and clevis arms 127 to form the connection. The opposing side of the lug fitting 131 includes a face 132 that abuts against a corresponding face of the fan cowl support beam 140.

The lug fitting 131 is connected to the fan cowl support beam 140 with one or more fasteners 150. The fasteners 150 include an elongated shape to extend through flanges on both the lug fitting 131 and the fan cowl support beam 140. The fasteners 150 include connectors such as nuts to secure the attachment. The number and positioning of the fasteners 150 can vary. FIGS. 4 and 5 illustrate one example that includes four fasteners 150, with other examples including more or fewer fasteners 150.

The fasteners 150 include an elongated shape to extend through both the lug fitting 131 and fan cowl support beam 140. In some examples as illustrated in FIGS. 4, 5, and 6, the fasteners 150 include a body 151 and a spacer 152. The body 151 includes a head that is positioned at one of the fan cowl support beam 140 and lug fitting 131, and an opposing threaded end configured to receive a nut. In some examples, the body 151 is a threaded bolt. In other examples, the body 151 is a rivet or other elongated member configured to support the connection.

The spacer 152 has a substantially cylindrical shape that extends around the body 151. The spacer 152 has a length that extends between a first end and a second end. In some examples, the length of the spacer 152 is less than the length of the body 151 such that the head and the threaded end of the body 151 are exposed. In some examples, the spacer 152 includes one or more openings. The shape and size of the openings can vary. In some examples as illustrated in FIGS. 4 and 5, the openings have an elongated shape with a relatively large length and narrow width. In some examples, the openings extend around the periphery of the spacer 152. In other examples, the openings extend around a limited portion of the spacer 152. In other examples, the spacer 152 is solid with no openings.

FIG. 6 illustrates a schematic sectional view of a fastener 150. The body 151 extends along a central section and is positioned within an interior space 153 formed by the spacer 152. In some examples as illustrated in FIG. 6, the body 151 is spaced a distance inward from the spacer 152. In other examples, the spacing is less with the body 151 contacting against and/or in closer proximity to the spacer 152.

The number, positioning, and shape/size of the fasteners 150 can vary. In some examples, each of the fasteners 150 are identical. This can facilitate manufacturing by reducing the number of different components. This can also facilitate assembly/maintenance as a technician is only required to attach one type of fastener 150. In other examples, two or more of the fasteners 150 have different shapes and/or sizes and/or constructions.

The spacer 152 is constructed to buckle during an FBO event. During buckling, the spacer 152 bends, deforms, collapse, or otherwise gives way under the force applied by the fan case 125. The buckling absorbs energy that is applied by the fan case 125 to the fan cowl support beam 140.

The body 151 is configured to withstand forces above the predetermined threshold that is applied during an FBO event. In some examples, the body 151 maintains its same shape. In other examples, the body 151 bends or otherwise changes shape when applied to the excessive force. The body 151 maintains its structural integrity during the FBO event and maintains the connection between the fan case 125 and the fan cowl support beam 140. In some examples, the buckled spacer 152 maintains structural integrity to further maintain the connection.

The fasteners 150 are designed to withstand the various loads during an FBO event. The loads include a large initial force that is exerted on the fan case 125 due to the contact with the one or more fan blades 113. The loads also include a large force/deflection wave that is generated and travels around the fan case 125 as the now unbalanced fan 112 continues to spin during engine rundown. After run down, the engine 110 will continue to windmill for the remainder of the flight in which the FBO event occurred which produces a high number of low load cycles due to the imbalanced load. In some examples, just the large initial force is above the predetermined threshold. In other examples, both the large initial force and one or more of the deflection wave forces are above the predetermined threshold.

The buckling of the spacer 152 absorbs a portion of the forces that are applied by the fan case 125 to the fan cowl support beam 140. In some examples, the buckling also enables the fan case 125 to move relative to the fan cowl support beam 140 thus absorbing some of the forces.

The direction of the forces that are applied by the fan case 125 can vary. In some examples, the mount 130 is configured to buckle upon the application of a tension force that exceeds the predetermined threshold. The force applied through the fan case 125 is directed away from the fan cowl support beam 140. This force causes one or more of the fasteners 150 to fail which includes one or more of the spacers 152 buckling due to the force. In other examples, the mount 130 is configured to buckle upon the application of a compressive force and/or torsion force.

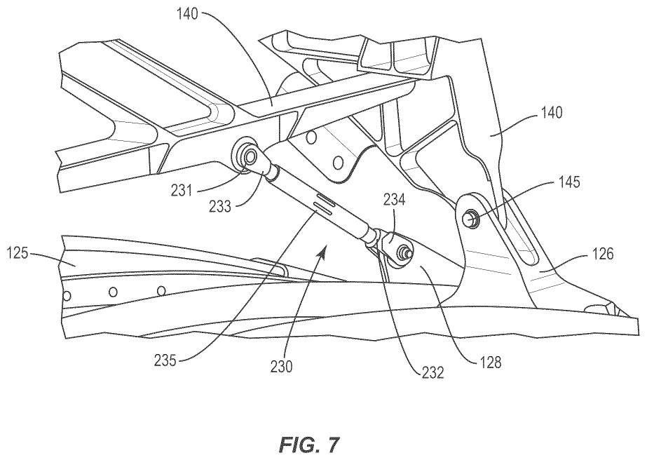

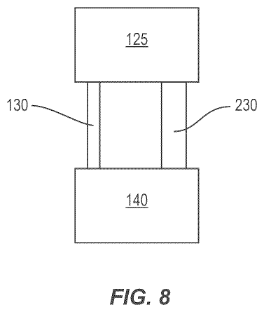

FIG. 7 illustrates a mount 230 that connects the fan case 125 to the fan cowl support beam 140. The mount 230 includes an elongated shape with a first end 231 that is connected to the fan cowl support beam 140 and a second end 232 that is connected to a fan case fitting 128. The mount 230 includes a spacer 235, a body 233 that makes up the first end 231, and a body 234 that makes up the second end 232. The first end 231 is configured to be connected to the fan cowl support beam 140 and the second end 232 configured to be connected to the fan case 125. The mount 230 includes a spacer 235 that connects body 233 to body 234 between the first end 231 and the second end 232. In some examples, the bodies 233, 234 are separate members that are connected together by the spacer 235. Upon application of a force above a predetermined threshold, the spacer 235 is configured to buckle to absorb a portion of the force to protect the fan cowl support beam 140. In other examples, the mount 230 is a single unitary member with body 233, body 234, and spacer 235 being configured from a single integral piece. The spacer 235 is configured to buckle to absorb the force.

The spacer 235 has a substantially cylindrical shape that extends around sections of the bodies 233, 234. The length of the spacer 235 measured between the ends 231, 232 can vary. In some examples, the spacer 235 includes one or more openings. The shape and size of the openings can vary. In some examples as illustrated in FIG. 7, the openings have an elongated shape with a relatively large length and narrow width. In some examples, the openings extend around the periphery of the spacer 235. In other examples, the openings extend around a limited portion of the spacer 235. In other examples, the spacer 235 is solid or hollow with no openings.

The spacer 235 is constructed to buckle during an FBO event. During buckling, the spacer 235 buckles to absorb energy that is applied by the fan case 125 to the fan cowl support beam 140. The buckling can also enable the fan case 125 to move relative to the fan cowl support beam 140.

The mount 230 is configured to connect the fan case 125 to the fan cowl support beam 140. The mount 230 also absorbs forces that are applied by the fan case 125 to the fan cowl support beam 140. The forces include one or more of compressive forces, tension forces, and torsional forces. Upon application of a force above a predetermined threshold, the spacer 235 buckles thus absorbing a portion of the force and protecting the fan cowl support beam 140. The mount 230 maintains structural integrity to keep the fan case 125 connected to the fan cowl support beam 140. In some examples, after the spacer 235 initially buckles, it can subsequently “debuckle” and buckle again during cyclical loading, continuing to absorb a portion of the compression and tension loads and protecting the fan cowl support beam 140.

Each of mount 130 and mount 230 connect the fan case 125 to the fan cowl support beam 140. The predetermined threshold at which buckling occurs can be the same or different for the mounts 130, 230.

In some examples as illustrated in FIGS. 4 and 5, just one or more mounts 130 connect the fan case 125 and fan cowl support beam 140. In some examples as illustrated in FIG. 7, just one or more mounts 230 connect the fan case 125 to the fan cowl support beam 140. In other examples as schematically illustrated in FIG. 8, one or more of each of the different mounts 130, 230 connect the fan case 125 to the fan cowl support beam 140.

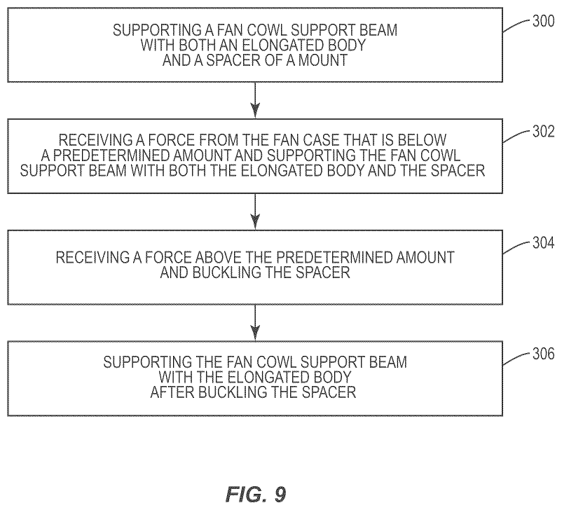

FIG. 9 illustrates a method of connecting a fan cowl support beam 140 to a fan case 125. The method includes supporting the fan cowl support beam 140 with both an elongated body and a spacer of a mount (block 300). While supporting the fan cowl support beam 140, receiving a force from the fan case 125 that is below a predetermined amount and supporting the fan cowl support beam 140 with both the elongated body and the spacer (block 302). This relatively low force does not cause the spacer to buckle. Further, while supporting the fan cowl support beam 140, receiving a force above the predetermined amount and buckling the spacer (block 304). After receiving the excessive force, supporting the fan cowl support beam 140 with the elongated body after buckling the spacer (block 306).

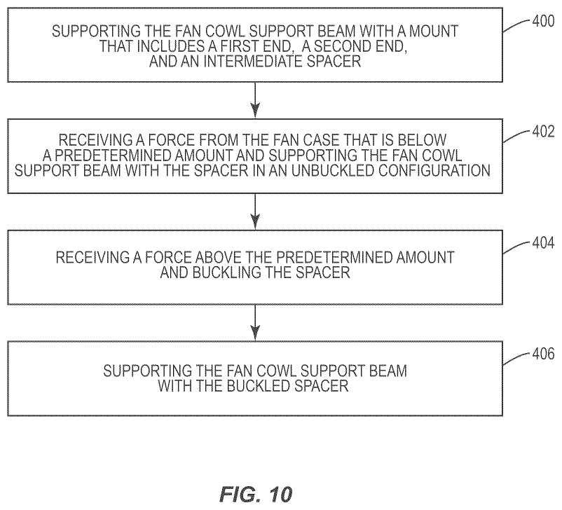

FIG. 10 illustrates another method of connecting a fan cowl support beam 140 to a fan case 125. The method includes supporting the fan cowl support beam 140 with a mount 230 with a first end 231 connected to the fan cowl support beam 140 and a second end 232 connected to the fan case 125 (block 400). A mount 230 includes a spacer 235 positioned between the first end 231 and the second end 232. While supporting the fan cowl support beam 140, receiving a force from the fan case 125 that is below a predetermined amount and supporting the fan cowl support beam 140 with the spacer 235 in an unbuckled configuration (block 402). While supporting the fan cowl support beam 140, receiving a force above the predetermined amount and buckling the spacer 235 (block 404). After receiving the excessive force, supporting the fan cowl support beam 140 with the buckled spacer 235 while the mount 230 remains connected to the fan cowl support beam 140 and to the fan case 125 (block 406).

In some examples, after initially buckling due to the application of the excessive force, the spacer 235 goes through a series of buckling/de-buckling during the cyclical loading.

One application for the mounts 130, 230 is for use with an aircraft 100 as described above. Other applications include but are not limited to dynamic types of events that have high loads cycling for a short period of time which can occur at different locations on the aircraft 100. Other applications include other contexts on the aircraft 100.

The mounts 130, 230 can also be used in a variety of other contexts to connect together first and second members.

By the term “substantially” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A mount to connect a fan cowl support beam to a fan case, the mount comprising:
a fitting with a first end configured to connect to the fan case and a second end;
a plurality of fasteners that connect the second end of the fitting to the fan cowl support beam, the plurality of fasteners comprising:
an elongated body;
a spacer that extends around the body;
wherein the spacers are configured to buckle upon application of a force from the fan case that is above a predetermined amount to absorb a portion of the force;
wherein the elongated bodies are configured to withstand the force and maintain the connection between the fitting and the fan cowl support beam.

2. The mount of claim 1, wherein the fasteners comprise the spacers having a cylindrical shape with a hollow interior and with one of the elongated bodies extending through the hollow interior.

3. The mount of claim 2, wherein one or more of the spacers comprises one or more slots that extend along a length.

4. The mount of claim 1, wherein one or more of the elongated bodies comprises a threaded bolt.

5. The mount of claim 1, further comprising the fitting comprising a flange at the second end and with the plurality of fasteners extending through the flange to connect the fitting to the fan cowl support beam.

6. The mount of claim 1, wherein two or more of the fasteners extend through each of a first side and a second side of the fitting.

7. The mount of claim 1, further comprising the second end of the fitting having a flat face that contacts against a corresponding face on the fan cowl support beam.

8. The mount of claim 1, wherein the spacer is configured to buckle upon the application of the force away from the fan cowl support beam.

9. A mount to connect a fan cowl support beam to a fan case, the mount comprising:
a first member with an outer end configured to be connected to the fan cowl support beam;
a second member with an outer end configured to be connected to the fan case, with the first member and the second member being colinearly aligned;
a spacer that extends around inner ends of the first member and the second member;
wherein the spacer is configured to buckle upon application of a force from the fan case that is above a predetermined amount;
wherein the mount is configured to maintain the connection between the fan case and the fan cowl support beam upon application of the force above the predetermined amount.

10. The mount of claim 9, wherein the first member and the second member are separate members connected together by the spacer.

11. The mount of claim 9, wherein the spacer comprises a cylindrical shape with a hollow interior that receives the inner ends of the first member and the second member.

12. The mount of claim 9, wherein the spacer comprises a plurality of slots that extend along the length and around a periphery of the spacer.

13. The mount of claim 9, wherein the spacer is hollow.

14. The mount of claim 9, wherein the spacer is solid.

15. A method of connecting a fan cowl support beam to a fan case, the method comprising:
supporting the fan cowl support beam with a mount;
receiving a force below a predetermined amount and supporting the fan cowl support beam with the mount in an unbuckled state;
receiving a force above the predetermined amount and buckling the mount; and
supporting the fan cowl support beam with the mount after buckling the mount.

16. The method of claim 15, wherein the mount comprises an elongated body with a spacer and receiving the force above the predetermined amount an buckling the spacer and absorbing a portion of the force that is passed from the fan case to the fan cowl support beam.

17. The method of claim 16, further comprising twisting the spacer when receiving the force that is above the predetermined amount.

18. The method of claim 16, further comprising buckling the spacer along slots that extend within the spacer.

19. The method of claim 16, further comprising maintaining a shape of the spacer when the force is below the predetermined amount.

20. The method of claim 16, wherein the elongated body comprises a first section that is connected to the fan cowl support beam and a second section that is connected to the fan case end and spacing apart the first section and the second section with the spacer.
